(19) United States
(12) Patent Application Publication
(10) Pub. No.: US 2019/0070720 A1
(43) Pub. Date: Mar. 7, 2019

(54) HAND-HELD POWER TOOL

(71) Applicant: Robert Bosch GmbH, Stuttgart (DE)

(72) Inventors: Maik Rabe, Reutlingen (DE); Heiko Roehm, Stuttgart (DE); Katharina Hopp, Stuttgart (DE)

(21) Appl. No.: 16/084,406

(22) PCT Filed: Mar. 20, 2017
(86) PCT No.: PCT/EP2017/056587

§ 371 Date: Sep. 12, 2018

(30) Foreign Application Priority Data
Mar. 21, 2016 (DE) 10 2016 204 629.2

(51) Int. Cl. B25F 5/00

(52) U.S. Cl. CPC B25F 5/001; B25B 23/147

(57) ABSTRACT

A hand-held power tool includes a housing that includes a handle, a drive motor situated in the housing for driving a mechanical interface such as a tool holder, a first electronics system situated in the housing, an a switch situated on the housing for controlling a function setting that is changeable by an operator.

### CROSS-REFERENCE TO RELATED APPLICATIONS

The present application is the national stage of International Pat. App. No. PCT/EP2017/056587 filed Mar. 20, 2017, and claims priority under 35 U.S.C. § 119 to DE 10 2016 204 629.2, filed in the Federal Republic of Germany on Mar. 21, 2016, the content of each of which are incorporated herein by reference in their entireties.

### FIELD OF THE INVENTION

The present invention relates to a hand-held power tool, in particular, a combi drill or a cordless combi drill, including a tool holder which can be set into rotation and is drivable by a drive motor via a gear.

### BACKGROUND

Hand-held power tools such as baton screwdrivers, cordless combi drills, or drilling machines are known from the related art and generally include a housing including a tool holder which can be set into rotation and is drivable by a drive motor via a gear, and at least one operating element, using which a control of the gear and/or of the motor is made possible.

Moreover, hand-held power tools such as rotary impact screwdrivers are known, which include a switching element, via which the operator can switch, for example, a worksite lighting or a special operating mode on and off, or can increase or decrease an idling speed by tapping. Other hand-held power tools such as combi drills include a mechanical interface, to which attachments (for example, a hammer attachment) can be fastened, which change the nature or the function or the intended use of the hand-held power tool.

WO2015/061370 A1 describes a hand-held power tool which exchanges data, parameters, or the like with an external unit with the aid of a wireless communication module, so that it is possible to define an operating mode on the basis of multiple parameters, transmit the operating mode to the hand-held power tool, and activate the operating mode on the hand-held power tool.

### SUMMARY

An object of the present invention is to improve hand-held power tools with respect to the outlay and the costs for the manufacturer as well as with respect to a more comfortable operation for the operator.

An object of the present invention is to improve a hand-held power tool such that a transmission of user-defined data, parameters, or the like to the hand-held power tool is possible using a simple design measure and, simultaneously, an easy operation with respect to the defined parameters on the hand-held power tool is ensured and a variable adaptation to other circumstances is easily implementable.

In example embodiments, such a hand-held power tool includes a housing including a handle, a drive motor situated in the housing for driving a mechanical interface, in particular a tool holder, a first electronics system situated in the housing, a device for supplying power, in particular a power supply unit or a rechargeable battery pack, and at least one first switching element situated on the housing that has a function setting which is changeable by an operator. In this way, the function setting of the first switching element on the hand-held power tool can be changed by the operator, the operator not being limited to predefined electrical functions and features or predefined parameters which are stored for a certain operating mode.

In an example embodiment, the assignment of the function setting of the first switching element, or the assignment of an electrical function and/or an electronic feature of the first switching element takes place via at least one wired or one wireless second switching element situated on the housing of the hand-held power tool and/or via a wireless external interface of an external electrical or electronic unit.

Preferably, the first switching element switches the electrical function assigned thereto and/or the electronic feature assigned thereto on or off. In an example embodiment, the electrical function assigned to the first switching element by the operator can be a light for a worksite lighting of the hand-held power tool. As soon as the function setting of the first switching element with the electrical function “light” has been carried out by an operator, the light for the worksite lighting can be switched on and off as necessary by an operator of the hand-held power tool with the aid of the first switching element.

In an example embodiment, a value of the electrical function assigned to the first switching element and/or of the electronic feature of the hand-held power tool, which is assigned to the first switching element, is changeable with the aid of the first switching element. Preferably, the first switching element as well as the second switching element is a push-button switch to be manually actuated, slide switches or the like alternatively also being conceivable. The user can therefore assign an electrical function and/or an electronic feature to the first switching element, freely configure the electrical function and/or electronic feature, and activate, deactivate, and/or vary the electrical function and/or electronic feature directly on the hand-held power tool with the aid of the first switching element. In an example embodiment, the electrical function which is assigned to the first switching element by an operator can be a light for a worksite lighting. As soon as the function setting of the first switching element to the electrical function “light” has been carried out, the luminosity of the light for the worksite lighting can be varied as necessary by an operator of the hand-held power tool with the aid of the first switching element. The luminosity can be increased or decreased. In this way, the value of the electrical function can be changed with the aid of the first switching element. In yet another example embodiment, the light can be switched on and off or activated and deactivated and the luminosity can be changed or varied.

An electrical function is to be understood to mean, in particular, a function which influences the operation of the hand-held power tool. In this case, the electrical function can influence the operation of a drive motor or the operation of another electrical component of the hand-held power tool, for example, the operation of a lighting unit for a worksite lighting of the hand-held power tool. In an example embodiment, a light, a current, a current limitation, a voltage, a voltage limitation, a rotational speed, a rotational speed limitation, a torque, a torque limitation, a power, a power limitation, a number of impacts, a limitation of a number of impacts, and/or a function of a component integrated into the hand-held power tool, in particular, of a sensor, for example, an acceleration sensor, a rotation rate sensor, a light sensor, a magnetic sensor, a current sensor, a voltage sensor, and/or a temperature sensor is/are assignable as an electrical function. In this context, the function of a sensor is understood to mean, in particular, the detection of a certain operating state. For example, the function of a sensor, in particular, of an acceleration sensor or a rotation rate sensor, can be the detection of a case of blocking. In one further example, the function of a sensor, in particular, of a temperature sensor, can be the detection of an overheating of an electrical or electronic component of the hand-held power tool. In one further example, the function of a sensor, in particular, of a magnetic sensor or a light sensor, can be the detection of an attainment of a preset torque of a manually adjustable torque clutch of the hand-held power tool. In this case, the sensor detects the actuation or the response of the torque clutch by way of a detent of the one clutch half with respect to the other clutch half of the torque clutch. In yet another example, the function of a sensor can be the detection of an impact of an impact mechanism, in particular, by a rotary impact mechanism. In addition to the detection of a certain operating state, the function of a sensor can also be understood to mean a power limitation, in particular, a shutoff, of the drive motor. In this way, in the above-described examples of a function of a sensor upon detection of a certain operating state, a shutoff or a power limitation of the drive motor can take place. For example, the function of an acceleration sensor or of a rotation rate sensor upon the detection of a case of blocking can include a shutoff or a power limitation of the drive motor. Moreover, the function of a temperature sensor upon the detection of an overheating of an electrical or electronic component of the hand-held power tool can include a shutoff or a power limitation of the drive motor. Moreover, the function of a sensor upon detection of a certain predefined torque can be a shutoff or a power limitation of the drive motor. The function of a sensor upon detection of an impact of an impact mechanism can also include a shutoff or a power limitation of the drive motor.

An electronic feature is to be understood to mean, in particular, a function in which a, in particular, physical property varies as a function of another, in particular, physical property and/or of a profile. In this way, in one further example embodiment, an electronic feature is, for example, at least one, in particular, physical property in at least one dependence, in particular, of at least one other, in particular, physical variable, and/or a progression. In particular, a luminosity, a current, a voltage, a rotational speed, a power, a torque, or a number of impacts can vary as a function of another physical property. In this way, for example, a profile of the luminosity as a function of the motor speed or a profile of a motor current as a function of the motor speed can be stored as the electronic feature. Moreover, a clutch detent, a sensor triggering threshold, a sound level, and/or a suction power can be selectable.

In this way, an electrical function and/or an electronic feature such as the luminosity of a worksite lighting, the threshold value for the function of a sensor, or values of various control variables of the drive motor, in particular, the setting of rotational speed, torque, and/or the like, can be assigned to the first switching element by the operator and can be influenced by the operator via the first switching element on the hand-held power tool. Due to the fact that the operator can assign an electrical function and/or an electronic feature to the first switching element, the operator can configure the hand-held power tool according to the operator's needs. The operator can assign to the first switching element the electrical function and/or the electronic feature which are/is most important for the operaor's work cases. Due to the fact that the operator, after the assignment of the electrical function and/or the electronic feature, can change the value of the function and/or of the feature with the aid of the first switching element, the operator can optimize the hand-held power tool, for example, for individual work cases. There is no need in this case to reassign a value which has been optimized, for example, for the special work case, to the function and/or the feature. By way of the second switching element, however, either the assignment of the function setting of the first switching element can take place and/or another electrical function is variable.

In this case, it is advantageous when the electrical function and/or the electronic feature are/is selectable from a stored database or is freely definable by the operator. In this way, a database in which the electrical function and/or the electronic feature are/is stored can be accessed for the assignment of the electrical function and/or the electronic feature. The operator can select, in this case, from a selection of existing electrical functions and/or electronic features. Alternatively, an electronic feature can be freely defined by the operator for the assignment. In this way, the operator can define the chronological sequence of a physical property, for example, with reference to a diagram, and subsequently assign the chronological sequence to the first switching element. This enables the operator to attain a maximum adaptation of the hand-held power tool to the operator's individual needs.

In this way, it is possible that the operator assigns the electrical function and/or the electronic feature to the first switching element with the aid of the external interface or the second switching element. Thereafter, the value of the electrical function and/or of the electronic feature can be adjusted via the first switching element, whereby the electrical function and/or the electronic feature can be changed directly on the hand-held power tool without the need to operate the external interface in advance.

In an example embodiment, the operator can also freely define a sequence of functionsusing the external interface. In this way, for example, a brief idling can be made possible in order to cool the hand-held power tool after its use or a brief operation can be made possible after a reversal of the direction of rotation of the hand-held power tool after shutoff for the purpose of removing the installed attachment.

Moreover, it is possible that the operator of the hand-held power tool, after an exchange of the detachably mountable attachment, can also carry out a change of the function setting, so that a function setting of the first switching element, which is optimal for the corresponding attachment, can take place. In this way, a function setting can be configured, for example, for a rotary impact screwdriver attachment, in which a dependence of the rotational speed on the amperage is applied. Alternatively, the first switching element can also be assigned a function actuation of another electrical device, so that, for example, a switching on/off or a time-delayed switching on/off of an external unit such as a light, a radio, or a vacuum cleaner can be synchronized with the hand-held power tool.

The operator can therefore freely configure and assign the electrical function and/or the electronic feature of at least one first switching element. After the function setting has been assigned, the value of the assigned electrical function and/or of the electronic feature can be changed by the operator directly on the first switching element. In this case, the operator is advantageously not limited to parameters which have been defined and preset at the factory also with respect to the subsequent adjustability of the values of the assigned electrical function and/or of the electronic feature.

If, for example, “light” is assigned as the electrical function and “on/off” is assigned as the electronic feature or as the functionality to the first switching element, the “light” can be switched on or off by the operator directly on the first switching element. In principle, the electrical function as well as the electronic feature can be selected from a library and/or be freely defined by the operator, where, for example, a diagram curve can be freely drafted into axes of coordinates by the operator and the assignment of an inflection point or a gradation can be freely defined or set by the operator. Moreover, the dependence underlying the feature can also be defined directly as a formula. Preferably, this is implemented via a software-based app.

Advantageously, after a change has been made to the function setting of the first switching element, in particular, after a change has been made to the electrical function and/or the electronic feature of the hand-held power tool, an acoustic and/or visual signal is output to the operator.

Advantageously, the at least one first switching element situated on the housing includes an LED display or lighting fixtures, the LED display outputting a defined visual signal to the operator, in particular, after a change has been made to the electrical function and/or the electronic feature of the hand-held power tool or when the control unit is awake or is supplied with electrical energy. In this way, the operator can recognize, for example, on the basis of a backlighting of the first switching element, whether the assigned electrical function and/or the assigned electronic feature is activated or not. Alternatively, the assigned setting and/or the set values can be displayed preferably in the spatial proximity of the first switching element, for example, with the aid of an LED display on the housing of the hand-held power tool.

Moreover, it is advantageous that the LED display includes at least one visual icon, the icon indicating the selected electrical function and/or the selected electronic feature, for example, a lamp icon or a WLAN icon.

In an example embodiment, the interface includes a fixedly or detachably installed radio module for the contactless exchange of data with an external interface of an external unit, the radio module receiving and/or transmitting a radio signal, a Bluetooth signal, in particular a Bluetooth low energy signal, a WLAN signal, a visual signal, or an acoustic signal. In this way, it can be ensured that a data exchange or the assignment of the electrical function and/or the electronic feature can take place with the aid of the external interface of the external unit.

In principle, the radio module is an electrotechnical component which is utilized for establishing a communication link via a radio network in highly diverse ranges. In this way, radio modules are already utilized, for example, for applications in the so-called machine-to-machine (M2M) field, such as in the area of industrial automation, in motor vehicles for assisting applications in the area of telematics, or even for the remote access to utility meters such as electricity, gas, or water meters. In general, due to the use of a radio module, it is made possible to carry out a wireless data transmission via a radio network, whereby, in particular, efforts for otherwise necessary wiring are avoided. In this way, a transmission of data, parameters, or the like from and to an external interface can be reliably made possible using a simple design measure.

As a preferred exemplary embodiment of such a radio module, for example, a WLAN module, for example, an 868 MHz module or a 915 MHz module, or even a Bluetooth module can be utilized. Further types of radio modules are also usable. The radio network can be a communications network of an arbitrary wireless communication standard, such as WLAN (Wireless Local Area Network), Bluetooth, GSM (Global System for Mobile Communications), GPRS (General Packet Radio Service) or UMTS (Universal Mobile Telecommunications System). In addition, wireless communication networks having a comparatively short range, which have been specially adapted to the appropriate requirements and are also referred to as a “Wireless Personal Area Network (WPAN),” are being utilized to an increasing extent, in particular, in the area of industrial automation. Examples thereof are, for example, radio networks according to one of the standards IEEE 802.15.4 or WirelessHART.

In order to enable the interface to be supplied with sufficient power in a simple way, it is provided according to an example embodiment of the present invention that the radio module, in particular, the interface, is supplied with energy via the power supply of the hand-held power tool. This is ensured with the aid of a detachable connection of the interface to the power supply and/or to the energy store of the hand-held power tool.

Alternatively, it is conceivable that the radio module includes a separate energy store which is situated within the interface housing, the radio module being electrically connected to the power supply of the hand-held power tool and/or to the separate energy store. According to the present invention, it is provided that the radio module is supplied with energy via the power supply of the hand-held power tool in the event that the power supply of the hand-held power tool is present and has sufficient energy; and is supplied via the separate energy store in any other case. In this way, a power supply of the radio module can be ensured at any time.

In general, a hand-held power tool is to be understood to mean, for example, rotary impact screwdrivers, baton screwdrivers, hammer drills, angle grinders, jigsaws, saber saws, planers, grinders, milling cutters, impact drills, multi-function tools, combi drills, cordless drills, cordless screwdrivers, and/or cordless combi drills. The hand-held power tool includes a gear for transmitting a torque generated by a drive motor to a drive shaft and, for example, various drill bits, bit attachments, or core bits can be utilized as tools.

An example embodiment of the present invention is directed to an electrical unit other than the hand-held power tool, such as, in particular, a radio, a lamp, or a suction unit, including a housing as well as a first electronics system situated in the housing, and a device for supplying power, in particular a power supply unit or a rechargeable battery pack, characterized in that at least one first switching element situated on the housing has a function setting which is changeable by an operator.

The hand-held power tool according to the present invention can also be provided in a tool system. A hand-held power tool therefore also forms, together with an external unit which includes an external interface, one further subject matter of the present invention. According to the present invention, it can be provided that the external unit is a smartphone or an electronic data processing system, for example, a PC, a laptop, or a tablet.

“Transmission of electrical energy” is to be understood to mean, in this context, in particular, that the hand-held power tool conducts energy to the drive motor via a power cable connection to the body and/or via a rechargeable battery in the housing.

Further features, possible applications, and advantages of the present invention result from the following description of exemplary embodiments of the present invention, which are represented in the figures. It should be noted that the represented features merely have descriptive character and can also be used in combination with features of other above-described refinements and are not intended to restrict the present invention in any way. The present invention is explained in greater detail in the following with reference to preferred exemplary embodiments, in connection with the drawings, which are schematic.

### BRIEF DESCRIPTION OF THE DRAWINGS

FIG. 1 shows a side view of a hand-held power tool according to an example embodiment of the present invention.

FIG. 2 shows a perspective view of the hand-held power tool of FIG. 1 according to an example embodiment of the present invention.

FIG. 3 shows a perspective detailed view of the interface from FIGS. 1 and 2 according to an example embodiment of the present invention.

FIG. 4 shows a progression of the luminous intensity as a function of the rotational speed according to an example embodiment of the present invention.

FIG. 5 shows a progression of the current draw as a function of the rotational speed according to an example embodiment of the present invention.

### DETAILED DESCRIPTION

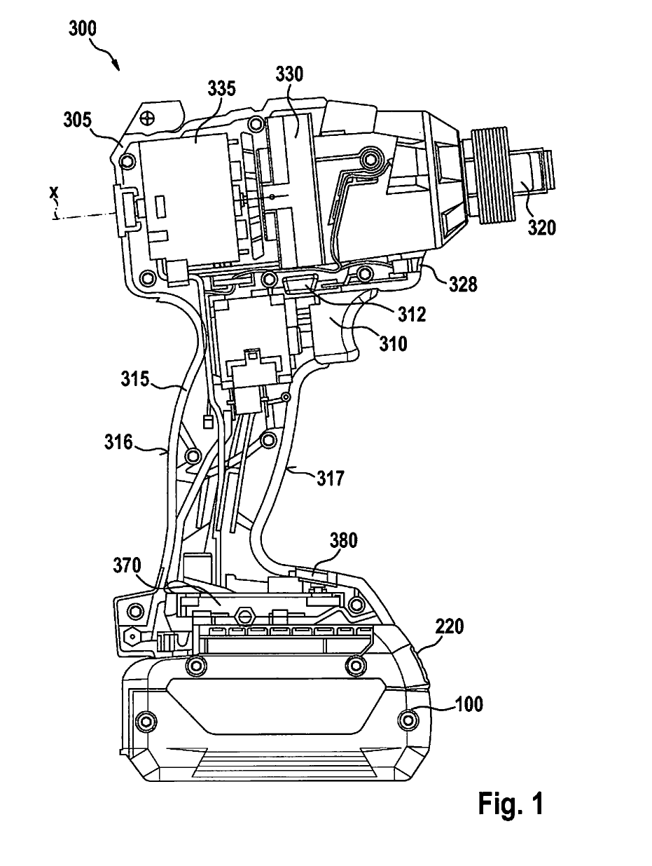

FIG. 1 shows an electrical device, which is configured as hand-held power tool 300, which is configured as a cordless rotary impact screwdriver, by way of example. In the represented specific embodiment, hand-held power tool 300 is therefore mechanically and electrically connected to a rechargeable battery pack 100 for battery-supplied power. However, the present invention is not restricted to cordless rotary impact screwdrivers, but rather can be utilized with different hand-held power tools 300, regardless of whether the hand-held power tools are operated with the aid of a rechargeable battery pack 100 as the battery-supplied power, as represented, or with the aid of a mains-supplied power. Hand-held power tool 300 includes a gear 330 situated in a housing 305 for transmitting a torque generated by a drive motor 335 to a drive shaft, which is rotating about a rotational axis x and on which a tool holder 320 for a detachable tool attachment (not depicted) is fastened, and includes a handle 315. An electronics system 370 is situated within housing 305 and is in electronic and/or mechanical contact with drive motor 335 and/or gear 330. Handle 315 is utilized as a support surface for a hand of an operator of hand-held power tool 300 and generally has a longitudinal axis y, a front side 317, which points in the direction of tool holder 320 along an axis x, a back side 316, and two lateral faces.

A first operating element 310 for the power supply of drive motor 335 is situated in the area of handle 315, first operating element 310 protruding from housing 305 so as to be manually accessible by the user, so that a control and/or regulation of the drive motor can be made possible preferably as a function of the adjustment travel of first operating element 310 in a way which is known per se by way of a pressing movement of first operating element 310, in order to switch the voltage supply for drive motor 335 on and/or off. Furthermore, hand-held power tool 300 includes a second operating element 312 in the form of a slide switch for adjusting the direction of rotation of drive motor 335 of hand-held power tool 300. Second operating element 312 is movably situated perpendicular to rotational axis x of the drive shaft, in particular of tool holder 320 of hand-held power tool 300, so that second operating element 312, upon actuation, can be moved back and forth between a first position, a second position, and a third position. In this case, the first and the second positions each establish a direction of rotation of the drive motor. The user of hand-held power tool 300 can therefore detect in which working mode hand-held power tool 300 is operating based simply on the positions of second operating element 312. In addition, second operating element 312 includes a third position between the first position and the second position, for example, a middle position, an electrical, electromechanical, and/or mechanical interruption of the motor current taking place in the third position. In this way, for example, the operation of first operating element 310 can be mechanically blocked, second operating element 312 acting upon first operating element 310 in a locking manner when moved into a third position. In this case, second operating element 312 can be designed as a slide switch, as represented, or as a toggle switch.

First operating element and second operating element 310, 312 are situated along rotational axis x in such a way that it is possible to actuate both first and second operating elements 310, 312 using the index finger or the thumb. In this case, the distance between first operating element 310 and second operating element 312 is selected in such a way that a single-handed operation of hand-held power tool 300 is possible. The two operating elements 310, 312 are furthermore situated in an area underneath rotational axis x and protrude from housing 305.

Hand-held power tool 300 includes a lighting element 328 integrated into housing 305, which is utilized as a worksite lighting and/or as an operating state indicator. Rechargeable battery pack 100 represented in FIG. 1 is designed as a sliding rechargeable battery pack. During the mounting of rechargeable battery pack 100 on hand-held power tool 300, receiving means provided on hand-held power tool 300, for example, guide grooves and guide ribs, are brought into engagement with corresponding guide elements of rechargeable battery pack 100, rechargeable battery pack 100 being inserted in a sliding direction along the receiving means of handle 315 and rechargeable battery pack 100 is pushed along a lower outer surface 300 of handle 315, which is oriented essentially perpendicularly to rotational axis x of handle 315, into the rechargeable battery pack receptacle of a hand-held power tool 300. In the position shown in FIG. 1, rechargeable battery pack 100 is fastened on handle 315 of hand-held power tool 300 and is locked with the aid of locking means. The locking means include, inter alia, a locking element and an actuating element 220. By way of the actuation of actuating means 220, rechargeable battery pack 100 can be released from handle 315 of hand-held power tool 300. Furthermore, hand-held power tool 300 includes an interface 380 to a first switching element 382 and a second switching element 384. In one alternative embodiment (not represented), interface 380 includes only first switching element 382 or multiple first switching elements 382, but not a second switching element 384.

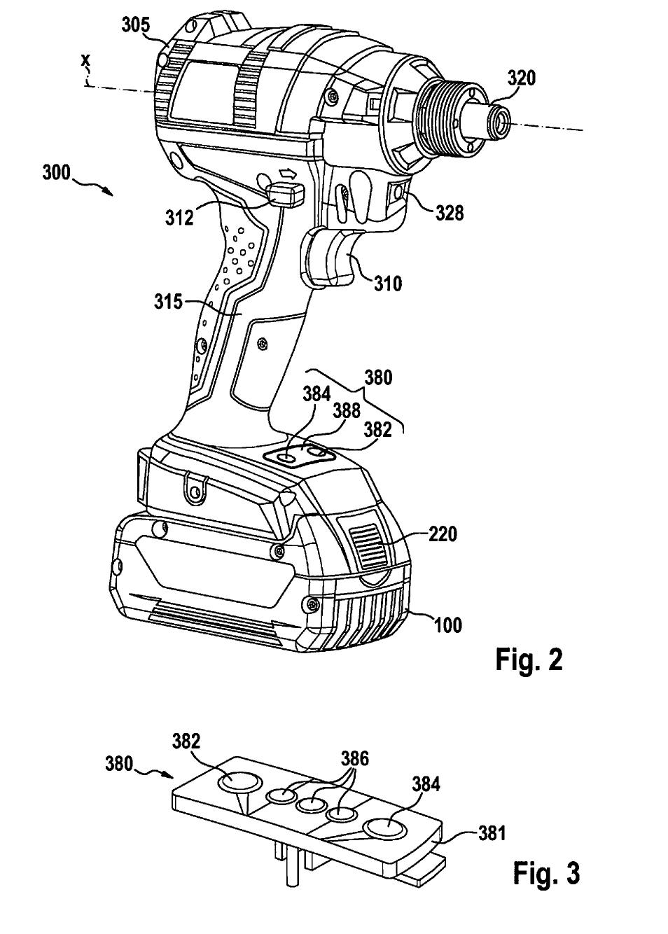

FIG. 2 shows a perspective view of hand-held power tool 300 from FIG. 1. Interface 380 is situated in an area above rechargeable battery pack 100 and below first operating element 310. In this way, the operation of hand-held power tool 300 is not interfered with by the arrangement of interface 380.

Alternatively, interface 380 can be closeable with the aid of a cover 388, cover 388 preferably being implementable so as to be curved in such a way that cover 388 follows a contour of housing 305 and terminates flush therewith. Correspondingly, cover 388 can be designed from different plastic materials such as PA6 (Gebamid B), PA6.6 (Gebamid A), PC (polycarbonate), ABS (acrylnitrile butadiene styrene copolymer), or from a material mix of various plastics, and/or can be designed to be glass fiber-reinforced, where it is advantageous when cover 388 includes the same material as housing 305 and handle 315 of hand-held power tool 300.

As represented in detail in FIG. 3, interface 380 includes at least one first switching element 382. In the specific embodiment shown in FIG. 3, interface 380 includes, in particular, two switching elements, a first switching element 382 and a second switching element 384. Moreover, interface 380 includes a radio module which is not represented in detail and contacts a control unit 370 and is configured for receiving information and transmitting information to control unit 370, which is situated within housing 305, and/or to a second external interface (not represented). In one alternative example embodiment (not represented), the radio module can also be provided at another suitable position in or on hand-held power tool 300. The radio module can be installed, for example, on the outside of housing 305. The radio module can also be situated, for example, within housing 305 in the area of handle 315. The arrangement of the radio module can be carried out in a suitable way by those skilled in the art. The radio module is configured for receiving and/or transmitting a radio signal, for example, a Bluetooth signal, a WLAN signal, or an acoustic signal. Correspondingly, the radio module contacts control unit 370 of hand-held power tool 300 via a wireless or wired connection. The radio module can be connected either fixedly or detachably to the hand-held power tool. In this way, the radio module can be fixedly integrated or installed into interface 380 or into housing 305 of hand-held power tool 300 or the radio module can be detachably integrated or installed into interface 380 or housing 305.

The at least one first switching element 382 has a function setting which is changeable by an operator, the function setting of first switching element 382 taking place either via at least one wired switching element 384 situated on housing 305 or via a wireless external interface (not represented). Thus, according to example embodiment of the present invention, the operator, in a first step, assigns an electrical function and/or an electronic feature to first switching element 382 via the external interface, for example, with the aid of a smartphone or an electronic data processing system and/or a second switching element 384, the initial button setting carried out by the manufacturer being deleted. Moreover, the operator can assign an appropriate value or a control variable to the selected electrical function and/or the electronic feature. Thereafter, the operator can operate the selected electrical function and/or the electronic feature directly on hand-held power tool 300 via first switching element 382. In one alternative button setting, a regulation of the value or the control variable of the electrical function and/or the electronic feature of hand-held power tool 300, which has been assigned to first switching element 382, is also changeable by the operator with the aid of first switching element 382.

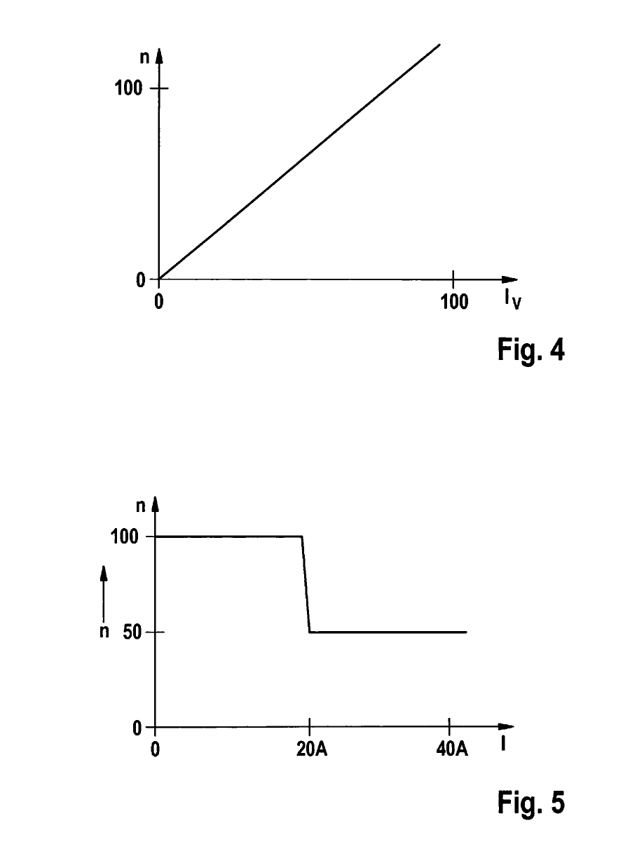

In this way, the operator can assign to first switching element 382, as the electrical function, for example, a current limitation, a rotational speed limitation, a torque limitation, a light, or a function of an integrated component, in particular of a sensor, for example, an acceleration sensor, a rotation rate sensor, a light sensor, and/or a temperature sensor, and can select, as the electronic feature, for example, at least one property in the form of a dependence and/or a profile, in particular, of a luminosity, a current profile, a rotational speed profile, a power, a torque, and/or a number of impacts. In this way, for example, in FIG. 4, motor speed n is plotted against luminosity IV and, in FIG. 5, the dependence of motor speed n on amperage I. The represented linear dependence between motor speed n and luminosity IV means, for example, that a 50-percent motor speed n is assigned to a 50-percent luminosity IV. The linkage of the dependences represented in FIGS. 4 and 5 yields a dependence of luminosity IV and motor speed n on amperage I.

With the aid of the external interface and/or second switching element 384, the electrical function as well as the electronic feature can be selected from a library. Moreover, the electrical function as well as the electronic feature can be freely defined by the operator with the aid of the external interface in such a way that the operator freely assigns, for example, a parameter such as motor speed n or luminosity IV to the two axes; where the diagram curves can be linear, stepped, progressive, degressive, or can include inflection points. In principle, the diagram curve can be freely drafted by the operator into axes of coordinates, where the assignment of an inflection point or gradation, such as in FIG. 5 at 20A, can be freely defined or set. Moreover, the dependence underlying the feature can also be defined directly as a formula. Preferably, this is implemented via a software-based app.

In this case, the operator of hand-held power tool 300, after an exchange of a detachably mountable attachment, can also carry out a change of the function setting, so that a function or feature setting of first switching element 382, which is optimal for the corresponding tool attachment, can take place.

Alternatively, first switching element 382 can also be assigned a function setting of another electrical device (not represented), so that, for example, a switching on/off or a time-delayed switching on/off of an external unit such as a light, a radio, or a vacuum cleaner can be synchronized with the switching on/off of hand-held power tool 300.

For example, the operator can select the heading “worksite lighting” under “functions” on the app, whereupon a submenu including different electrical features or functionalities opens in the app. For example, the submenu would list the subpoints “light on/off,” “luminosity depending on motor speed on/off,” and/or “reduce luminosity in steps.” The operator can select a functionality from these subpoints and assign this functionality to first switching element 382. If the operator has selected, for example, the functionality “light on/off” and has assigned this functionality to first switching element 382, the operator can switch the worksite lighting on or off in the future via the actuation of first switching element 382. If the operator selects the functionality “reduce luminosity in steps” and assigns this functionality to first switching element 382, upon every actuation of first switching element 382, the operator reduces the luminosity of the worksite lighting or jumps from entirely dark to full luminosity.

According to the present invention, the operator can therefore freely configure and assign the electrical function and/or the electronic feature of at least one first switching element 382 via the wireless second switching element 384 and/or via the wireless external interface. After the function setting has been assigned, the value of the assigned electrical function and/or of the electronic feature can be changed by the operator directly on first switching element 382. Advantageously, the operator is not limited to parameters which have been defined and preset at the factory when it comes to assigning the function setting.

After a function setting of first switching element 382 has taken place and/or after a change of the function setting has taken place, an acoustic and/or visual signal is output by interface 380 to the operator, interface 380 including, in this regard, at least one display element 386, in particular multiple LED display elements, whereby a backlighting, for example, of display element 386 and/or interface 380 and/or individual switching elements 382, 384 can be made possible, so that the operator can immediately recognize that the assigned function setting is activated.

In an alternative example embodiment, interface 380 includes at least two switching elements 382, 384. Via the external interface, the function “change function or feature of another switching element” can be assigned to first switching element 382.

In addition to the described and illustrated specific embodiments, further specific embodiments are conceivable, which can include further modifications and combinations of features.

1-15. (canceled)

16. A hand-held power tool comprising:
a housing that includes a handle;
a drive motor situated in the housing for driving a mechanical interface;
a first electronics system situated in the housing;
a power supply; and
a first switch situated on the housing with a function setting that is user changeable.

17. The hand-held power tool of claim 16, wherein the power supply is a rechargeable battery pack.

18. The hand-held power tool of claim 16, wherein the mechanical interface is a tool holder.

19. The hand-held power tool of claim 16, wherein the function setting of the first switch takes place via at least one wired or wireless second switch situated on the housing.

20. The hand-held power tool of claim 16, wherein the function setting of the first switch takes place via an interface for wireless communication with an external device.

21. The hand-held power tool of claim 20, wherein the interface for the wireless communication includes a fixedly or detachably installed radio module for the contactless exchange of data with an interface of an external unit, the radio module being configured to at least one of receive and transmit a radio signal, a Bluetooth signal, a WLAN signal, a visual signal, or an acoustic signal.

22. The hand-held power tool of claim 16, wherein the first switch is operable to switch on and off any one or more of the following: an assigned electrical function, an assigned electronic feature of the hand-held power tool, and an electronic feature of another electrical device.

23. The hand-held power tool of claim 16, wherein the first switch is operable to change a value of any one or more of the following: an electrical function assigned to the first switch, an electronic feature of the hand-held power tool assigned to the first switch, and an electronic feature of another electrical device assigned to the first switch.

24. The hand-held power tool of claim 16, wherein the function setting assigned to the first switch is changeable to any one or more of the following: a light function, a current limitation setting, a speed limitation setting, a torque limitation setting, and a setting of a function of an integrated component.

25. The hand-held power tool of claim 16, wherein the function setting assigned to the first switch is changeable to a setting of a function of any one or more of the following: an acceleration sensor, a rotation rate sensor, a light sensor, and a temperature sensor.

26. The hand-held power tool of claim 16, wherein the function setting is changeable to one in which the first switch controls the setting in dependence on a luminosity, a current profile, a rotational speed profile, a power, a torque, a clutch detent, a sensor triggering threshold, a sound level, a suction power, or a number of impacts.

27. The hand-held power tool of claim 16, wherein the first switch is operable to switch on and off an electrical function that is selectable from a stored database or that is freely user-definable.

28. The hand-held power tool of claim 16, wherein the hand-held power tool is configured to output one or both of an acoustic signal and a visual signal in response to a change to the function setting of the first switch.

29. The hand-held power tool of claim 16, further comprising an LED display on the housing, wherein the hand-held power tool is configured to output a visual signal via the LED display in response to a change to the function setting of the first switch.

30. The hand-held power tool of claim 29, wherein the LED display includes at least one visual icon representing the function setting to which the first switch has been changed.

31. The hand-held power tool of claim 16, wherein the hand-held power tool is a rotary impact screwdriver, a baton screwdriver, an impact drill, a multi-function tool, a combi drill, a cordless drill, a cordless screwdriver, or a cordless combi drill.

32. A system comprising:
a hand-held power tool that includes:
a housing that includes a handle;
a drive motor situated in the housing for driving a mechanical interface;
a first electronics system situated in the housing;
a power supply;
a first switch situated on the housing with a function setting that is user changeable; and
a wireless interface; and
an external unit that includes a wireless interface and with which the hand-held is configured to communicate via the wireless interfaces of the hand-held power too and the external unit.

33. The tool system of claim 32, wherein the external unit is a smartphone or an electronic data processing system.

34. An electrical unit comprising:
a housing;
a first electronics system situated in the housing;
a power supply; and
a first switch situated on the housing with a function setting that is user changeable.

35. The electrical unit of claim 15, wherein the electrical unit is a radio, a lamp, or a suction unit.

36. The electrical unit of claim 15, wherein the power supply is a rechargeable battery pack.
